(19) United States
(12) Patent Application Publication
(10) Pub. No.: US 2007/0070976 A1
(43) Pub. Date: Mar. 29, 2007

(54) Mobile and packet-based call control

(76) Inventors: Harry Edward Mussman, Bedford, MA (US); Wen K. Han, Lexington, MA (US); Michael T. Wilhoite, Chicago, IL (US); Lee Goodman, Tyngsboro, MA (US); Tom Joyner, Chicago, IL (US); Sanjay S. Jhawar, Chicago, IL (US); Steven H. Blumenthal, Lexington, MA (US)

Correspondence Address: FISH & RICHARDSON PC, P.O. BOX 1022, MINNEAPOLIS, MN, 55440-1022, US

(21) Appl. No.: 11/492,698

(22) Filed: Jul. 25, 2006

Related U.S. Application Data
(60) Provisional application No. 60/702,118, filed on Jul. 25, 2005.

(51) Int. Cl. H04L 12/28

(52) U.S. Cl. 370/351; 455/445

(57) ABSTRACT

A telecommunication approach provides telephone service to subscribers on terminals registered on a mobile network that are consistent with the services provided to those subscribers at terminals on a fixed communication network. For instance, the subscriber on the terminals on the mobile network may have access to mid-call features and private dialing plans that are supported using elements on the fixed network, and calls placed to the subscribers at addresses (e.g., wireline numbers or SIP addresses) on the fixed network may be delivered to their terminals on the mobile network.

### CROSS-REFERENCE TO RELATED APPLICATIONS

This application claims the benefit of U.S. Provisional Application No. 60/702,118, filed Jul. 25, 2005. This application is incorporated herein by reference.

This application is also related to U.S. application Ser. No. 11/183,534, titled “Handoff for Cellular and Internet Protocol Telephony,” filed Jul. 18, 2005, and to U.S. application Ser. No. 10/463,111, titled “Circuit switched cellular network to Internet calling with Internet Antennas,” filed Jun. 16, 2003. These applications are incorporated herein by reference.

### BACKGROUND

This invention relates to call control involving mobile telephone and packet-based networks.

Mobile telephone networks typically maintain location information about a subscriber to enable call delivery to the user regardless of the location of the user on the telephone network. A Home Location Register (HLR) includes a database of permanent subscriber information for a mobile network. The HLR is an integral component of CDMA (code division multiple access), TDMA (time division multiple access), and GSM (Global System for Mobile communications) networks. Maintained by the subscriber's home carrier (or the network operator where the user initiated the call), the HLR contains pertinent user information, including address, account status, and preferences. The HLR interacts with a Mobile Switching Center (MSC), which is a switch used for call control and processing. An MSC also serves as a point-of-access to the Public Switched Telephone Network (PSTN—the “fixed” wireline network). A third integral element is a Visiting Location Register (VLR), which maintains temporary user information (such as current location) to manage requests from subscribers who are out of the area covered by their home MSC.

When a call is placed to a user's mobile telephone, the mobile network queries the HLR to determine which MSC and associated VLR is currently serving the user. The serving MSC provides a temporary local directory number (TLDN) to which a wireline circuit is completed and through which the voice call is made to the user's mobile telephone.

When a mobile user initiates a call, the mobile network switching equipment determines whether or not the call is coming from the device's home area. If the user is out of the home area, the VLR for the area the call is coming from sends out a request for information required to process the call. The HLR provides the information, which it relays to the appropriate MSC, which in turn relays it to the VLR. The VLR sends routing information back to the serving MSC which allows it to find the station where the call originated, and, finally, the mobile device to connect. Communications between the elements are based on Signaling System (SS7) protocols and signaling.

Voice-over-IP (VoIP) systems include mechanisms for directing calls to a user based on an address, a Universal Resource Indicator (URI). One approach to establishing calls uses the Session Initiation Protocol (SIP). The SIP architecture uses URIs (e.g., user@domain) to identify endpoints, and includes various infrastructure components, including registrars, which map URIs to IP addresses or host names, redirection servers, which signal indirection back to a source of a call, and proxy servers. SIP can in principal offer a device limited mobility to calls, for example, by reregistration of the device with its home registrar. However, the SIP infrastructure is generally designed to provide services to fixed and stationary devices.

Today, VoIP systems generally function independently of mobile telephone systems and do not have methods to exchange call information with a mobile telephony network.

### SUMMARY

In one aspect, in general, a telecommunication approach provides telephone service to subscribers on terminals registered on a mobile network that are consistent with the services provided to those subscribers at terminals on a fixed communication network. For instance, the subscriber on the terminals on the mobile network may have access to mid-call features and private dialing plans that are supported using elements on the fixed network, and calls placed to the subscribers at addresses (e.g., wireline numbers or SIP addresses) on the fixed network may be delivered to their terminals on the mobile network.

In another aspect, in general, a method for providing telecommunication services includes accepting at a first element a signal indicative of a call to a subscriber at an address on a fixed network. The call is extended to a second terminal that is registered on a mobile telephone network via a packet-based data network. Extending the call includes receiving a signal indicative of the call at a second element coupled both to the mobile telephone network and to the packet-based data network, and routing the call to the terminal based on routing information available to the second element.

Aspects can include one or more of the following features.

The address on the fixed network comprises a wireline telephone number, or comprises VoIP network address, such as a SIP URI.

The first element comprises a switch, or comprises a packet-based voice server.

At the first element it is determined whether to route the call to a first terminal associated with the address on the fixed network and/or to the second terminal registered on the mobile network.

If the call is not completed to the second terminal on the mobile telephone network, the call is handled in the same manner as if the call were note completed to a first terminal associated with the address on the fixed network. For example, handling the call comprises routing the call to a message server on the fixed network.

Communication services are provided to the second terminal by emulating corresponding packet-based voice terminal by the second element in communication with the first element.

Call features are provided using the first element to a subscriber at the second terminal. For example, mid-call features are provided.

Extending the call to the second terminal further comprises obtaining the routing information at the second element from the mobile network.

Outbound calling features are provided from the second terminal registered on the mobile network via the first element. For example, the outbound calling features include a private dialing plan feature.

In another aspect, in general, private telephone features are provided at terminals registered on a mobile telephone network. A first element is configured to provide private telephone features and a second element is coupled to the mobile telephone network and coupled over a packet-based data network to the first element. A call placed between a first terminal registered on the mobile telephone network and another terminal is processed. This processing includes passing mobile network signaling information for the call between the first element and the second element.

Aspects can include one or more of the following features.

The call placed between the first terminal and the other terminal is a call placed from the first terminal or a call placed to mobile telephone number associated with the first terminal.

Passing signaling information for the call between the first element and the second element includes passing a routing request from the second element to the first element. For example, the routing request includes a dialed number in a private dialing plan.

The signaling information can include a mid-call feature request initiated at the first terminal from the second element to the first element.

Routing information is passed from the first element to the second element. For example, the routing information includes an identification of the other terminal, the other terminal being registered on the mobile network.

The call between the first element and the second element is routed over the packet-based data network.

The packet-based network includes the public Internet or a private IP network.

In another aspect, in general, a system enables redirecting a call between the mobile network and a packet switched network, and determines the location of a mobile-telephone for purposes of call delivery between the public domain mobile network and a radio transceiver connected to the packet-switched network. The system can include a component that translates call control protocols, such as the Session Initiation Protocol (SIP), used on the packet-switched network to the signaling common to mobile telephone networks.

In another aspect, in general, a gateway device interfaces with a voice server, for example, a SIP-based voice server. The gateway interfaces with a mobile telephone system, and provides a presence of mobile devices on the voice server, such that the mobile devices can make and receive calls mediated by the voice server. The mobile devices may also make use of services on the voice server, for example, voice mail, 4-digit (extension number) dialing, etc.

In another aspect, in general, a communication system includes a second element coupled to a mobile telephone network and coupled to a packet-based data network over which a first element is accessible. The second element is configured to extend private telephone features provided by the first element to mobile terminals registered on the mobile network.

Aspects can include one or more of the following features.

The second element interfaces with the mobile telephone network as a mobile switching center (MSC) and/or as a service control point (SCP).

The system further includes the first element, which may include a voice server or a voice call feature server such as an IP PBX or an IP Centrex system.

Advantages of one or more aspects can include one or more of the following:

A subscriber has access to a consistent set of features independent of whether they are at a fixed wireline or VoIP terminal or whether they are at a mobile terminal registered on the mobile radio network or on a private IP domain (e.g., using a dual-mode telephone).

Callers to the subscriber are presented with consistent call handling independent of whether a call to the subscriber's fixed address is routed to a fixed terminal or to a mobile terminal. For example, the call can be routed to the same wireline voice mail system even if the call is route to the mobile network but not answered by the subscriber.

Mobile IP carries implementation complexity issues and can entail significant per-packet costs due to non-optimum routing. As compared to an approach to call deliver to a mobile VoIP phone using Mobile IP, one or more aspects of the present approach may increase efficiency because there is no need for home or foreign agents and no triangular or rectangular routing. Privacy can also be improved, and the system can be more resistant to targeted denial-of-service attacks.

One or more aspects of the present approach can provide advantages over approaches based on the UMA architecture that do not necessarily use any form of standards compliant VoIP such as SIP or H.323 because such approaches do not interoperate with any standard SIP call control elements such as SIP soft-switches or SIP IP PBXs.

A cost and/or performance advantage may be achieved by not requiring a circuit connection from an MSC when a call is redirected from the mobile network to a VoIP telephone.

Calls can be received from or delivered to IP PBX in SIP mode from a mobile telephone operator instead of having to passes over the PSTN as circuit-switched calls.

Redirection of a call to a VoIP telephone allows a choice of codec that is not limited to those supported by the MSC. For example, high quality, higher bandwidth VoIP codecs can be used when a call is redirected to a VoIP phone.

The approach is applicable to 2G and 2.5G GSM, as well as to CDMA 1xRTT, 1xEVDO, 1xEVDV and W-CDMA.

A difference between wireline and wireless SIP servers is the way phone numbers are assigned and what constitutes a local calling area. Wireline numbers are assigned according to geography, with the first three digits after the area code traditionally corresponding to a specific neighborhood or similar-size area known as a “rate center.” Wireless numbers typically cover a much larger calling area. Because mobile subscribers roam freely from rate center to rate center, multiple neighboring rate centers can be associated in the present approach whereas conventional wireline SIP server must generally honor existing wireline LATA and rate center boundaries.

Mobile user can dial reduced digits for internal extension when the user is the mobile network. For example, a call is connected to dialed party at a 10-digit telephone number when a 4-digit extension is dialed.

Enterprise user dials abbreviated extension, call is connected to the mobile user via cellular network.

When a mobile user does not answer cellular phone when called, the call is then redirected to IP-PBX/Centrex controlled Voicemail. The voicemail is retrieved from enterprise mailbox instead of mobile voicemail.

A user can receive a call on his work phone number at a home office IP phone. The user can leave home and transfer the call to his mobile telephone (e.g., via an IP PBX controlled function) and continues conversation. When the user arrives in the office, he can transfer the call to his desk IP phone while remaining in the same conversation.

User receives a call on their mobile phone. The user then “parks” the call so that the conversation can be resumed by other devices. The parked call is then picked up at an enterprise desk phone by invocation.

A user is on their mobile phone and conferences in two other callers. One user can be conferenced via an abbreviated enterprise number while another caller is conferenced via a cellphone number. The user's PBX controls the conferencing of all parties.

An enterprise does not need to change its infrastructure or add new features in order to extend features to mobile terminals. The enterprise continues to control calls.

PBX features can be extend to other networks—mobile, PSTN, and VoIP.

Use of an NCG coupled to the mobile network and a PBX significantly simplifies the PBX interface to mobile network.

Inbound calls to a mobile number can be treated by a PBX.

Outbound calls to mobiles can be least-cost routed over IP, thereby avoiding the PSTN.

Approaches can work with existing devices, such as PSTN phones, mobile phones, and IP phones.

Approaches can work without changes to a mobile network's HLR and MSC elements.

A user's work number can be used as the user's primary number while providing connectivity to the user when they are registered on a mobile network or using a VoIP terminal remote from the user's work location.

Other features and advantages of the invention are apparent from the following description, and from the claims.

### DRAWINGS

FIG. 1 is a block diagram of a communication system.

FIG. 2 is a block diagram of a communication system.

### DESCRIPTION

A number of embodiments are described below. Section heading are provided as an aid to the reader and should not be viewed as limiting the description according to the text of the headings or by the inclusion or exclusion of text in any particular section.

A number of prior patent applications are included by reference. In a case of any conflict between the description below and the material that is incorporated by reference, the description below should govern.

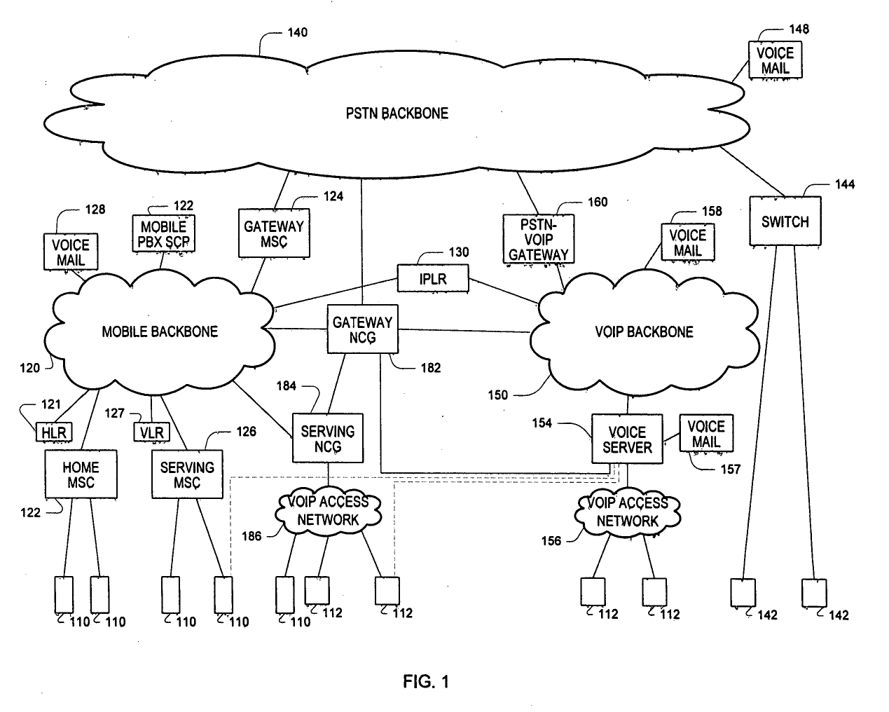

Referring to FIG. 1, a communication system includes a Public Switched Telephone Network (PSTN) 140 interconnected with representative mobile telephone and voice-over-IP (VoIP) networks. The mobile telephone network includes a mobile backbone 120, which includes fixed control and media networks, and a number of elements connected to the backbone. In general, the mobile telephone network follows either IS41 or GSM protocols, in either case operating in a similar manner. The mobile network is based primarily on time division multiplexed (TDM) technology for passing voice of active telephone calls. However, some Voice over Internet Protocol (VoIP) elements may be included in the mobile network, for example, having been introduced as networks are upgraded.

Traditional wireline voice networks, for instance that make up the PSTN 140, are based primarily on TDM voice switches and related equipment. However, VoIP-based elements and arrangements are being introduced, including various IP Access Networks, Voice Servers, plus Media Gateways and Media Gateway Controllers to interface with the existing TDM-based elements. For instance, a VoIP gateway 160 provides an interface between the PSTN backbone 140 and a VoIP backbone 150. This gateway provides a control and media path for TDM based calls to pass from the PSTN backbone to the VoIP backbone on which the voice is passed as a series of data packets as compared to being passed in fixed rate “time slots” that are preassigned and reserved for the voice data.

The communication system shown in FIG. 1 supports a variety of approaches providing telephone services to subscribers using a variety of telephone terminals or other devices, including wireline telephones 142 connected to one or more switches 144 of the PSTN, mobile telephones 110, which communicate via the mobile network and optionally function as “dual-mode” devices also capable of communicating over a VoIP access network 186, and VoIP phones 112, which may be coupled via a voice server 154 such as an enterprise IP PBX, which may be on the premises of the enterprise, a network-based server providing IP Centrex service, or a voice feature server. Note that although a number of different approaches are described below, different versions of the communication system may support only one or a subset of the approaches and include only components illustrated in FIG. 1 that are associated with those approaches.

Note that in FIG. 1, the VoIP backbone 150, and VoIP access networks 156 and 186 are shown as separate network. Some or all of these networks may be internetworked with the public Internet, layered on another internet (e.g., as a virtual network), or otherwise interconnected allowing packet communication to pass between them. These networks may also be private and not internetworked. For example, the VoIP backbone 150 may be a private IP based network operated by one or more telecommunication companies that does not carry general Internet traffic. Also, the mobile backbone 120 may itself include a packet-based component, for example, providing communication services between elements of the mobile network for establishing telephone calls with mobile telephones and carrying the associated voice traffic in packet form.

1 Case 1

In a first example, an approach to providing telephone services supports telephone calls between mobile telephones 110 within the mobile network and between mobile telephones 110 and wireline telephones 142 via the PSTN. For example, in the case of a call from a wireline telephone 142 to a mobile telephone 110, the call is routed by the PSTN according to the dialed number to a gateway mobile switching center (MSC) 124. Within the mobile network the call is routed from the gateway MSC 124 via the mobile backbone 120 to a serving MSC 126 and then to the mobile telephone 110. Note that only one serving MSC 126 is illustrated in FIG. 1 as an example. In general there are a number of serving MSCs in a mobile network in order to provide geographic coverage and to support call handoff capabilities. A mobile network generally uses either IS41 or GSM protocols, which although having differences basically operate in essentially the same manner.

The mobile network determines the serving MSC 126 to which to route the call according to registration information stored in the mobile network. When a mobile subscriber is registered with a serving MSC, there is an entry in a Visited Location Register (VLR) 127 that is associated with that MSC, and an additional entry in a central Home Location Register (HLR) 121, which identifies the current serving MSC for the subscriber. The HLR 121 also includes subscriber profiles for all subscribers who could be registered on the mobile network.

In this example, operation of the system can be understood according to the following exemplary steps:

Step 1: When a subscriber, using a mobile telephone 110 or other terminal is associated with the serving MSC 126, the subscriber's profile is requested by the serving MSC 126and retrieved from the HLR 121 then stored in the serving MSC 126. An entry for the subscriber is placed in the Visitor Location Register (VLR) 127 that is within or associated with the serving MSC 126, and a pointer is placed in the HLR 121 indicating that the subscriber is mobile-registered in the serving MSC 126.

Step 2: When a call comes in from the PSTN for particular MDN/MSISDN for the subscriber, the gateway MSC 124 receives the call from the PSTN backbone 140 and needs to find a route to that subscriber's terminal, assuming that the subscriber is currently registered. The gateway MSC 124 first sends a Location request to the HLR 121, which then returns the last known location of the subscriber, at the serving MSC 126. The gateway MSC 124 then sends a Route request to the serving MSC 126. Assuming that the subscriber is currently registered, the serving MSC 126 returns a TLDN/MSRN to the gateway MSC 124.

Step 3: The gateway MSC 124 then routes the call via the mobile backbone 120 using the TLDN/MSRN to the serving MSC 126, which then completes the call to the subscriber's terminal 110.

Step 2b: When a subscriber is not registered on the mobile network (for example because the subscriber's phone is does not have its radio powered on or is out of range of the network), and the gateway MSC 124 checks with the HLR 121, it may find a pointer to the serving MSC 126 where the subscriber was last registered, but, when it sends a Route request to the serving MSC 126, it finds that the subscriber is no longer registered. Then, the gateway MSC 126 obtains the subscriber's profile from the HLR 121. The subscriber's profile specifies the intended call treatment for the situation in which the subscriber is not registered. This treatment is typically to route the call to a voice mail component 128 of the mobile network.

Step 3b: In a third case, the gateway MSC 126 finds that the subscriber is still registered to the serving MSC 126 and routes the call there using the TLDN/MSRN, but the call doesn't complete because the subscriber rejects the call, is busy, or does not answer. Again the appropriate call treatment is provided based on the subscriber's profile that is retrieved from the HLR 121 and/or the reason provided by the serving MSC 126 for rejecting the call. In an IS41-based mobile network, the gateway MSC 126 determines the call treatment based upon the reason code received from the serving MSC 126 and the subscriber profile obtained from the HLR. In a GSM-based Mobile network, the serving MSC 126 determines the call treatment based on the subscriber's profile that it obtains from HLR.

In addition to the basic service of delivering inbound calls from the PSTN to a subscriber's MDN/MSISDN, the system also supports call delivery from one mobile telephone 110 to another mobile telephone 110 using a similar approach by which one serving MSC determines the serving MSC at with the destination telephone is registered. The system also supports outbound calling from a mobile telephone 110 via the PSTN.

2 Case 2

In a second example, a SIP-based Serving Network Convergence Gateway (NCG) 184 is coupled to the mobile backbone 120 and provides packet network connectivity to packet-based VoIP telephones 112 and to dual mode (wireless telephone and wireless LAN) telephones 110. In general, the serving NCG 184 supports a mechanism for providing mobile telephone services to the packet-based telephones 110 and 112 coupled to the serving NCG 184 over a VoIP access network 186, which can include a wired and/or wireless (“WiFi”) local area network (LAN) and can include a link over the public Internet coupling the telephones to the serving NCG 184.

An example of operation of an NCG in conjunction with other components of the mobile network is described in copending U.S. application Ser. No. 11/183,534, titled “Handoff for Cellular and Internet Protocol Telephony,” published as US2006/0116127A1 on Jun. 1, 2006. This application is incorporated by reference.

In general, to support a WiFi-connected terminal 112, the SIP-based Serving NCG 184 is added to the basic mobile network configuration. A subscriber can use WiFi-connected terminal 112 or dual mode handset 110 to register on the mobile network, and access the basic services of the mobile network in essentially the same manner as if they were connected via mobile telephone radio and a conventional serving MSC. In the case of the subscriber using a dual-mode handset 110, the handset can either operate on the mobile telephone radio network or on the WiFi network of the VoIP access network, although not at the same time.

Although the serving NCG 184 is based on the SIP VoIP protocol and technology for communication with the telephone terminals 112, it operates in the mobile network as if it was a conventional serving MSC that contains a VLR and can assign a TLDN/MSRN for voice call routing. The serving NCG 184 can be configured to operate either in IS41 and GSM Mobile networks. Since the serving NCG 184 is based on the SIP VoIP protocol and technology, it includes (or alternatively is associated with) Media Gateways and a Media Gateway Controller (MGC) that carry voice calls between the mobile backbone 120 and the VoIP access network 186.

In this example, the serving NCG 184 provides call treatment in the same situations where a serving MSC 126 provides call treatment. In particular, it provides call treatment for a subscriber on a GSM network, where the subscriber is registered using terminal 112 over the VoIP access network 112, but for whom an inbound call cannot be completed because the subscriber rejects the call, is busy, or doesn't answer.

For voice calls, the serving NCG 184 uses the SIP-protocol for signaling and the RTP protocol for carrying media between the VoIP terminals 112 and the Media Gateway Controller (SIP) plus the Media Gateways (RTP) of the serving NCG. The MGC uses ISUP-signaling to communicate over the mobile backbone 120, and the media gateways use a TDM voice-format to exchange voice data with the mobile backbone 120.

Since SIP signaling is used between the serving NCG 184 and the VoIP terminal 112, if an additional call is routed to the serving NCG 184 that is intended for terminal 112 that is already engaged in an active call, a SIP Invite is then extended from the serving NCG 184 to the terminal 112, even though the subscriber is currently engaged in an active call (or session). In response to the SIP Invite, the terminal 112 can indicate to the subscriber that another call (session) is pending and the subscriber can then choose to accept or reject the call using the terminal. If the subscriber accepts the second call, he or she may place the first call on hold or alternatively, the terminal may support two active calls, simultaneously. In a similar manner, yet further calls can be added to the terminal without necessarily terminating the existing calls.

Note that the ability to handle multiple simultaneous calls results from the use of SIP-signaling between the serving NCG 184 and the terminal 112, and the use of a VoIP access network 186, for example using WiFi access, that has the bandwidth to accommodate multiple RTP Media streams. In contrast, a mobile telephone 110 connected via a mobile telephone radio to serving MSC 126 in a conventional manner is limited to one media stream and one active call. When a second call is routed to the serving MSC intended for a subscriber engaged in an active call at a terminal 110, the serving MSC 186 uses signaling messages to inform the subscriber that a second call is waiting. Then the subscriber signals the serving MSC via SIP messages, for example, if he wants to hold the first call and accept the second call, or simply reject the second call.

3 Case 3

A third example involves conventional telephone calls between telephones 142 using a wireline network. For example, telephones 142 are coupled to the PSTN backbone 140 via one or more switches 144. Typically, there is also a network based voice mail system 148 coupled to the PSTN backbone.

Basic “end-office” service is provided to telephone 142 as part of the PSTN, where the Subscriber receives basic PSTN services including outbound calling to the PSTN, inbound calling to the wireline directory number (DN). Call treatment for calls to a subscriber's telephone 142 via a voice switch 144 is based upon the subscriber profiles stored within the voice switch. Typically, when a subscriber on a telephone 142 is busy or does not answer, an incoming call is routed to their message box on the voice mail system 148.

Another type of service that may be provided by a switch 144 is a “Centrex” service that supports a private calling plan between telephones 142 in a common enterprise. For example, the switch is configured to provide 4 or 5 digit calling between telephones 142 in a common enterprise, as well as direct inbound calling to the telephones from other telephones on the PSTN.

4 Case 3b

VoIP based elements can be added to a basic wireline network configuration described above. One such example includes a SIP-based voice server 154, a VoIP access network 156, including for example a local LAN or WiFi interconnects, and SIP-based telephones 112 connected to the access network. The voice server 154 is coupled over a VoIP backbone 150 to a VoIP-PSTN gateway 160, which connects the TDM-based PSTN network to the packet-based VoIP backbone 150 using one or more media gateways and a media gateway controller (not shown in FIG. 1). A SIP-based voice mail system 158 may also be reached via the VoIP backbone 150.

In such example, the voice server 154 is hosted in the telephone network and telephones 112 access the voice server over a VoIP access network. For example, the VoIP access network includes a local area network coupled to the Internet via private data links to the voice server. In other examples, some or all of the functionality of the voice server 154 may be hosted at a customer premises, for example, providing the functionality of a private branch exchange (PBX).

This arrangement can used to provide all basic end-office service as part of the PSTN, where the subscriber receives basic PSTN services including outbound calling to the PSTN, inbound calling to the wireline DN. This arrangement can also be used to provide basic services to an enterprise including outbound calling to the PSTN, inbound calling to a wireline PSTN directory number that is directly routed to a particular subscriber, and subscriber to subscriber calling based on a private dialing plan using 4 or 5 digit extension. Such an arrangement is often called an “IP-Centrex” system.

The voice server 154 can be based on a variety of signaling and media protocols, for example, based on the use of the SIP-protocol for signaling and the RTP protocol for media flows. In some case, the MGCP protocol is used to connect with phones 112 or interfaces are included on the voice server for analog phones (LADs).

Typically, SIP signaling is used between the voice server 154 and the media gateways and media gateway controller of the VoIP-PSTN gateway 160, and the VoIP-PSTN gateway uses ISUP signaling to communicate with the PSTN backbone 140. Also, SIP-based signaling can be used between the voice server 154 and SIP-based telephones 112, thereby multiple calls (sessions) to be supported

Many SIP-based voice servers, particularly those intended for enterprise (e.g., for IP-Centrex) applications, include a rich array of supplementary features. In many cases, they may allow a subscriber to configure various features via a Web interface, including specification of multiple appearances, dialing plan options, call treatment options, and follow-me-find-me services.

When there are multiple “appearances” for a subscriber then a call for the subscriber may, for example, be directed to ring multiple terminals simultaneously or in sequence.

When a follow-me, find-me feature service is enabled, a call may be delivered sequentially to a local extension (via the VoIP access network 156) and then, for example, if there is no answer via the PSTN to a PSTN directory number which may correspond to a wireline phone 142 or a mobile telephone 110.

Triggers can be specified for inbound and/or outbound call features when a subscriber uses a SIP-based telephone 112 via the voice server 154. For example, there maybe a second inbound call, which triggers an inbound call-waiting feature. For example, the voice server 154 may be configured to respond to a second inbound call by forwarding a SIP Invite message to the telephone 112. Then the subscriber can accept or reject the second call. If the subscriber accepts the second call, the voice server can put the first call on hold, or handles both the first and second calls simultaneously.

An example of a trigger for an outbound call features is used when a subscriber chooses to transfer the call, or chooses to add a third-party to the call. In such examples, the subscriber establishes a second call and merges it with the first call. When the voice server 154 and the telephones 112 are both SIP-based, the merging of the calls can be entirely accomplished within the telephone 112, including setting up the second call and merging the media entirely within the telephone. In some examples, the merging of the calls is done entirely within the voice server 154, for example, based upon an indication from the telephone using a “Switch-hook flash” action, or an equivalent SIP message. Typically, a subscriber sends a first Switch hook flash and the voice server then puts the first call on hold and be ready to accept digits for a second call. After a second call is established, the subscriber sends a second “Switch-hook flash” and the voice server merges the first call into this second call.

If the voice server and/or the telephone 112 are not based on SIP, there may be different implementation for the call-waiting feature. For example, the voice server may notify the subscriber with a beep-tone and the subscriber may use the phone to signal a response to the voice server using a “Switch-hook flash” action or an equivalent mechanism. Then, for example, the voice server, upon receipt of a Switch hook flash, puts the first call on hold and extends the second call to the telephone. Upon receipt of a second Switch-hook flash, the voice server 154 returns the first call and put the second call on hold.

Mid-call features whether inbound or outbound can be realized using two general approaches. The first approach uses a SIP-based telephone 112 to manage and to locally provide the features using SIP-based signaling for setting up and managing multiple calls to between the telephone and the voice server. The second approach provides the features within the voice server, managing features via switch hook flashes, DTMF digits from the telephone. This approach may be required, for example, when the telephone and voice server are not based on SIP, but it is also used, in some cases, where both are SIP-based.

5 Wireline Prime Service

Some examples of communication approaches involve what is referred to herein as “wireline prime” services in which as part of a telephone service to a subscriber voice calls are extended in certain situations from the voice switch 144 or the voice server 154 to a subscriber who is registered on the mobile network using elements of the communication system shown in FIG. 1 that are used in communication approaches described above.

In some such examples, the service allows the subscriber who is registered on the mobile network to utilize many or all of the supplementary services implemented as part of their telephone service and available to the subscriber when using a telephone 142 or 112.

In some examples, a subscriber registered on the mobile network is effectively connected to the voice switch 144 of voice server 154 allowing the user to receive calls as if they were directly connected to the that switch or server and be able to respond to inbound mid-call features and initiate outbound mid-call features. For example, in an IP-based PBX or IP-Centrex configuration of the voice server, calls from within the enterprise via its private dialing plan (e.g., a 5-digit extension) are delivered via the mobile network to a subscriber's mobile telephone 110, even though the mobile telephone is identified within the mobile network using the MSN/IMSI and the MDN/MSISDN.

In some examples, the subscriber may not be reachable from the PSTN using his mobile MDN/MSISDN, and is only be reachable via their wireline number. In examples in which the mobile subscriber is reachable from the PSTN, he may have a combination of both basic mobile service and a wireline prime service that extends their wireline calls to the mobile network.

In some examples of a wireline prime service, voicemail messages resulting from an inbound wireline call are stored only in the subscriber's voice mail box (which, for example, may be hosted at voice mail system 148 or SIP-based voice mail system 158). Such messages preferably are not stored in the mobile voicemail system 128, because it would be confusing and inconvenient if messages intended for the subscriber at their wireline telephone number were to be delivered to multiple voicemail boxes.

Specific examples of wireline prime services are described in more detail below.

6 Case 4

A first example of a wireline prime service is implemented to complete calls intended for a subscriber on a TDM-based voice switch 144 via the mobile network to the subscriber's mobile telephone. An exemplary series of steps in such a system is described below.

Step 1: Calls intended for subscriber's wireline telephone number, which is associated with a telephone 142 on the voice switch 144, are routed to the voice switch. The voice switch 144 implements a follow-me/find-me feature. When the call cannot be completed to the subscriber's telephone 142, which is directly connected to the voice switch, the switch extends a call through its trunk-side interface to the subscriber's mobile MDN/MSISDN via the PSTN backbone 140. Thus, in this situation, the voice switch 144 provides a translation from the subscriber's wireline directory number (DN) to the subscriber's mobile MDN/MSISDN.

Step 2: The call is routed through the PSTN backbone 140 to a gateway MSC 124 (which may be one of many gateway MSCs coupling the mobile backbone 120 to the PSTN backbone 140), which tries to complete the call to the subscriber's handset using techniques described above. If the call cannot be completed, the call is not be completed to the mobile voice mail system 128, but instead is released back to the PSTN. Such call treatment is indicated in the subscriber's profile within the HLR 121. Note that in this example, the gateway MSC 124 does not distinguish between calls made directly to the subscriber's mobile telephone and calls to the subscriber's wireline number that were extended by the switch 144 to the mobile network. Therefore, the subscriber profile that releases the unanswered calls back to the PSTN may not be suitable for or consistent with a basic mobile service for the subscriber.

Step 3: If the voice switch 144 sees that the call has been released prior to connect, it re-routes the call to the wireline voice mail system 148.

Note that in this example, a subscriber on a mobile handset does not have access to the supplementary features implemented in the voice switch 144.

7 Case 5

Another example of a wireline prime service makes use of a SIP-based Gateway Network Convergence Gateway (NCG) 182, which couples the VoIP backbone 150 and the mobile backbone 120. The gateway NCG 182 provides a specialized gateway into the mobile network, with access from the PSTN backbone 140 via Media Gateways and Media Gateway Controller (not illustrated) incorporated into or accessible from the gateway NCG.

Like a gateway MSC 124, the gateway NCG 182 connects to the SS7 network of the mobile backbone 120, and connects via Media Gateways and Media Controller Gateway incorporated into or accessible from the gateway MSC into the mobile backbone 120. The gateway NCG 182 identifies a serving MSC 126 for a subscriber and completes an inbound call to the subscriber's handset using the MDN/MSISDN. An exemplary series of steps are outlined below:

Step 1: Calls intended for subscriber's wireline directory number (DN) are routed to the voice switch 144, which implements a follow-me/find-me feature. When the call cannot be completed to the subscriber's phone 142 that is directly connected to the switch, the switch extends a call to a routing DN via its network (or trunk-side interface) and the PSTN backbone 140. Thus, in this situation, the voice switch 144 provides a translation from the wireline DN to the Routing DN.

Step 2: Using the Routing DN, the call is routed by the PSTN backbone 140 to the gateway NCG 182 via its associated media gateways.

Step 3: The gateway NCG 182 then translates the routing DN to the subscriber's mobile MDN/MSIDN and tries to complete the call to the subscriber's mobile telephone 110, assuming that the subscriber is currently registered. To do this, the gateway NCG 182 first sends a Location request to the HLR 121, which then returns the last known location of the subscriber at a serving MSC 126. The gateway NCG 182 then sends a Route request to the serving MSC 126. Assuming the subscriber is currently registered, the serving MSC 126 returns its TLDN/MSRN to the serving NCG.

Step 4: The gateway NCG 182 then routes the call via the mobile backbone 120 using the TLDN/MSRN to the serving MSC 126, which then completes the call to the subscriber's mobile telephone 110.

Step 3b: When a subscriber is not registered on the mobile network, and if the gateway NCG 182 checks with the HLR and it finds a pointer to a serving MSC 126 where the subscriber was last registered, when it sends a Route request to that serving MSC 126 it finds that the subscriber is no longer registered. Then, the gateway NCG 182 releases the call back to the PSTN irrespective of the subscriber's profile within the HLR.

Step 4b: In a third case, the gateway NCG 182 finds that the subscriber is still registered to the serving MSC 126 and routes the call there using the TLDN/MSRN, but the call doesn't complete because the subscriber rejects the call, is busy, or does not answer. Again the call is released back to the PSTN.

In an IS41-based mobile network, the gateway NCG 182, provides the call treatment based upon the reason code received from the serving MSC 126, and it can release the call back to the PSTN, irrespective of the Subscriber's profile within the HLR. Thus, in an IS-41 network, this example of a wireline prime service can be provided to the subscriber at the same time as a basic mobile service. That is, calls made directly to a subscriber's mobile telephone number are received from the PSTN at a gateway MSC 124 and the call treatment if the call cannot be completed is determined in the gateway MSC, which calls extended from the switch 144 are received from the PSTN at the gateway NCG where call treatment is determined if the call cannot be completed. Therefore, the gateway MSC and the gateway NCG can implement different call treatment, for example, with the gateway MSC passing unanswered calls to the voice mail 128 of the mobile network and the gateway NCG releasing the call back to the PSTN where it can be forwarded to the voice mail 148 for the wireline system.

In a GSM-based Mobile network, the serving MSC 126 provides the call treatment, based on the subscriber's profile obtained from the HLR 121. For the gateway NCG to comply with the subscriber's profile and release the call to the PSTN if the call is not completed to the subscriber's mobile telephone, the subscriber's profile in the HLR is set to provide no call treatment, and thus this example of wireless prime service cannot in general be provided to the subscriber at the same time as a basic mobile service modification of the operation of one or more elements of the mobile network. For example, to release the call to the PSTN in this situation and still preserve the ability to provide basic mobile services, each serving MSC can be arranged with a terminating trigger that recognizes calls from the Gateway NCG 182 and then provides a simple release if the call cannot be completed.

Step 5: If the voice switch 144 sees that the call has been released prior to connect, it routes the original call to the wireline voice mail 148.

Note that in this example of wireline prime service, the subscriber at a mobile telephone does not have access to the supplementary features in the voice switch 144.

8 Case 6

In another example of a wireline prime service, the network side of the voice server 154 communicates with the gateway NCG 182 via the VoIP backbone 150. In a general sense, this example is similar to the previous example in which the voice switch 144 communicates with the gateway NCG 182 via the PSTN backbone 140 with the function of the voice switch 144 being performed by the voice server 154.

As an alternative, the voice server 154 could interact with the gateway NCG 182 over the PSTN backbone 140 by communicating via the VoIP-PSTN gateway 160 and its associated media gateways and media gateway controller, and the communicating with the gateway NCG 182 from the PSTN backbone 140 via the media gateways and media gateway controllers associated with the gateway NCG 182. That is, in such an alternative, the media path would involve a conversion from packet based communication to TDM based communication at the VoIP-PSTN gateway 160 and a conversion from TDM based communication back to packet based communication at the gateway NCG 182.

In this example in which the SIP-based voice server 154 is used instead of a TDM-based voice switch 144, it is possible to establish packet based (e.g., VoIP) connectivity directly from a the voice server 154 to the gateway NCG 182, for example via the VoIP backbone 150, bypassing the PSTN backbone 140 and avoiding conversion from packet based to TDM based communication and back. Such a link can be considered a “SIP Trunk” that connects both these SIP-based platforms and bypasses the VoIP-PSTN gateway 160 and its associated media gateways and media controllers and bypasses the media gateways and media gateway controllers associated with the gateway NCG 182.

Unlike the previous example where a call is routed via the PSTN from the voice switch 144 to the gateway NCG 182, in that there is no need to introduce a routing DN that is mapped by the gateway NCG 182. Instead, the voice server 154 forwards the call directly to the gateway NCG 182 identifying the subscriber's MDN/MSISDN in a SIP message as the desired destination of the call. In other aspects, this example operates in essentially the same manner as the previous configuration, with the same characteristics and limits. An exemplary series of steps are outlined below:

Step 1: Calls intended for a subscriber's wireline directory number (DN) are routed to the voice server 154, which implements a follow-me/find-me feature. When the call cannot be completed to the subscriber's phone 112 that is directly connected to Voice the voice server, the voice server extends a call to the subscriber's MDN/MSIDN via its network (or trunk-side interface) and the VoIP Backbone network (i.e., along the “SIP trunk) to the gateway NCG 182. Thus, in this situation, the voice server 154 provides a translation from the wireline DN to the subscriber's mobile MDN/MSIDN.

Step 2: The gateway NCG 182 receives the call with the subscriber's MDN/MSIDN. Using approaches described above, the gateway NCG 182 tries to complete the call to the mobile subscriber's mobile telephone 110 (or equivalently to a SIP based phone 112 registered via a serving NCG 184 on the mobile network), assuming that they are currently registered. Specifically, the gateway NCG 182 first sends a Location request to the HLR 121, which then returns the last known location of the subscriber at a serving MSC 126. The gateway NCG 182 then sends a Route request to the serving MSC 126. Assuming the subscriber is currently registered the serving MSC 126 returns a TLDN/MSRN to the gateway NCG 182.

Step 3: The gateway NCG 182 then routes the call via the mobile backbone 120 using the TLDN/MSRN to the serving MSC 126, which then completes the call to the subscriber's mobile telephone 110.

Step 2b: When the subscriber is not registered on the mobile network and the gateway NCG 182 checks with the HLR 121, it finds a pointer to a serving MSC 126 where the subscriber was last registered, but when it sends a Route request to that serving MSC 126, it finds that the subscriber is no longer registered. Then, the gateway NCG 182 releases the call back to the voice server 154 irrespective of the subscriber's profile within the HLR.

Step 3b: In a third case, the gateway NCG 182 finds that the subscriber is still registered to the serving MSC 126 and routes the call there using the TLDN/MSRN provided by the serving MSC, but the call doesn't complete because the subscriber rejects the call, is busy, or does not answer. Again the call is released back to the voice server 154.

Call treatment when a call is routed to a serving MSC but cannot be completed is similar to the previous example. Specifically, in an IS41-based mobile network, the gateway NCG 182 provides the call treatment based upon the reason code received from the serving MSC 126, and it can release the call back to the voice server 154 irrespective of the Subscriber's profile within the HLR. Thus, in an IS-41 network, this wireline prime service can be provided to the subscriber at the same time as a basic mobile service. In a GSM-based Mobile network the serving MSC 126 provides the call treatment based on the subscriber's profile obtained from the HLR. To release the call in this situation, the subscriber's profile in the HLR is set to provide no call treatment and thus this wireline prime service cannot, in general, be provided to the subscriber at the same time as a basic mobile service. To release the call in this situation, and still preserve the ability to provide basic mobile services, each serving MSC can be arranged with a terminating trigger that recognizes calls from the gateway NCG and then provides a simple release if the call cannot be completed.

Step 5: If the voice server 154 sees that the call has been released prior to connect, it routes the original call to the subscriber's voicemail associated with the subscriber's wireline DN, for example to wireline voice mail 148 or to a voice mail system 157 handled directly by the voice server 154.

Note that in this example the subscriber on a mobile telephone does not have access to supplementary features provided by the voice server 154.

9 Case 6b

In another example, some of the functions of the gateway NCG 182 of the previous example are hosted in the voice server 154. Specifically, after the gateway NCG 182 receives a TLDN/MSRN from the serving NCG 126, it transfers the TLDN/MSRN back to the voice server 154. The voice server 154 then completes a call directly to the serving MSC 126 via the PSTN backbone 140, bypassing the gateway MSC 124.

10 IPLR

In another example, an “IP Location Register” (IPLR) 130 is linked to both the mobile backbone 120 and to the VoIP backbone 150. (Note that the name “IP Location Register” is not intended to connote any limitation on or required services of the device labeled as such). The IPLR 130 provides an interface between the mobile network and the VoIP network that enables, for example, delivery of VoIP calls to mobile telephones through the mobile network, or redirection of calls placed to a mobile telephone number to a VoIP telephone.

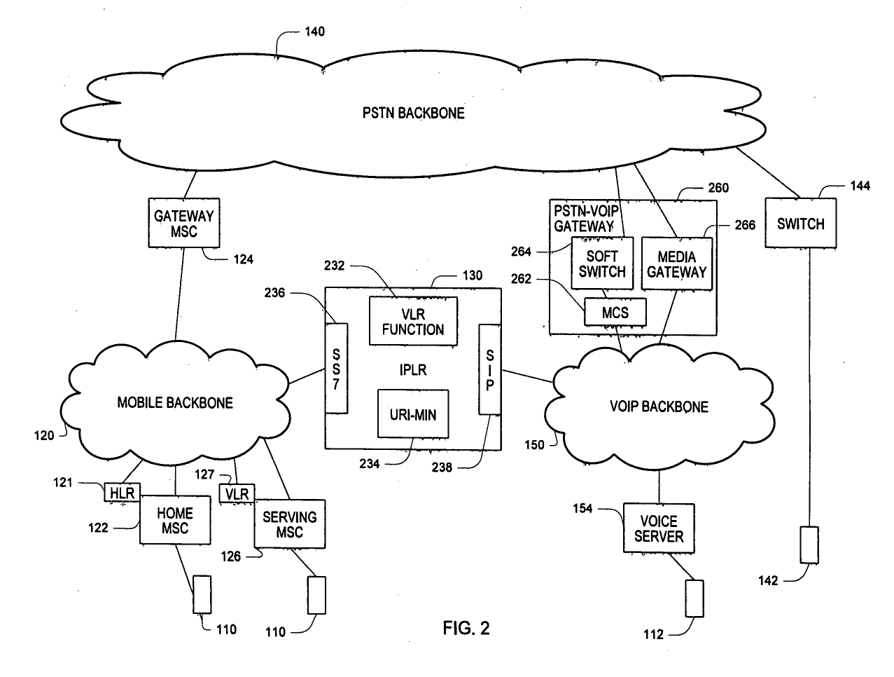

Referring to FIG. 2, in an example of a communication system that makes use of an IPLR 130, the VoIP backbone 150 has one or more SIP servers (e.g., SIP registrars, proxy servers etc.), for example voice server 154, that are used to establish VoIP calls. Note that the approach described herein is however applicable to other session control protocols (e.g., H.323), and other packet data communication protocols (e.g., other than IP or particular transport or application layer protocols).

The IPLR 130 and SIP servers on the VoIP backbone 150 serve some different purposes. For example, the SIP servers provide limited or no mobility. Such servers are generally designed primarily for fixed and stationary devices, such as VoIP phones 112. These SIP servers do not offer direct signaling capability (e.g., IS-41) with the mobile network 120, and do not act as a location register (e.g., as a VLR) for a mobile identity. On the other hand, the IPLR 130 can provide distinct and varying service options based on the location of a subscriber. The IPLR 130 compliment existing SIP servers, for example, by enabling signaling flow that integrates the IPLR with existing HLRs, MSCs, IP-based PBXs, Centrex systems and media gateways.

The communication system also includes a Multimedia Communication Server (MCS) 262, which along with a softswitch 264 and a media gateway 266 form a PSTN-VoIP gateway 260. The softswitch 264 and media gateway 266 contain ISUP SS7 connections to the PSTN on one side and SIP connections (and additionally or alternatively Megaco connections) on the other. The PSTN-VoIP gateway 260 provides a capability of interfacing the VoIP backbone 150 to the PSTN 140, and provides capability of forking calls to multiple destinations, for example, if multiple telephones are to be notified together of a call.

One capability supported by the IPLR 130 is delivery of calls from the VoIP network 150 to a mobile telephone 110 that is present on the mobile network. When the mobile telephone 110 is being served by the serving MSC 126, the telephone is registered with the VLR 127, and the HLR 121 has a record of the VLR 127 and the serving MSC 126 for that telephone. The IPLR 130 makes use of the registration information in the HLR and VLR in cause delivery of VoIP calls to the mobile network.

The IPLR 130 includes a URI-MIN database 234, which provides a mapping between Mobile ID Numbers (MINs) and Universal Resource Indicators (URIs). The IPLR 130 includes a SIP interface 238 to the VoIP backbone 150, which in one role acts as a SIP redirection server. The IPLR 130 receives a SIP “INVITE” message when a call is to be placed to a mobile subscriber, who is identified by a URI of the form “CalledParty@Carrier.com.” When the mobile subscriber is active on the mobile network, the URI-MIN database 234 includes an entry that maps the URI in the received INVITE message to a mobile network MIN.

The IPLR 130 includes a Signaling System 7 (SS7) interface 236 to the mobile backbone 120. The IPLR uses this interface to interact with the VLR 127 and HLR 121, and other components, of the mobile network. Based on the MIN determined from the URI-MIN database 134, the IPLR 130 determines where the call should be directed. Specifically, the IPLR 130 launches a location request to the HLR 121. In this example, the mobile telephone 110 associated with than MIN is being served by serving MSC 126, as is indicated in the HLR. The HLR 121 sends a Route Request to the serving MSC 126. In response to the Route Request, the serving MSC 126 assigns a temporary local directory number (TLDN) for the call, and returns that TLDN to the HLR 121, which in turn returns the TLDN to the IPLR 130. The IPLR 130 responds to the “INVITE” message with a “REDIRECT” message that identifies the TLDN to which the call is to be directed through the PSTN backbone 140. The mechanism for completing the call to the TLDN 127 is discussed after a description of functionality of the PSTN-VoIP gateway 260.

The PSTN-VoIP gateway 260 includes the MCS 262. One function of the MCS 262 is to act as a SIP server that can receive an INVITE message for a SIP call. In the case of a SIP call to a mobile subscriber's telephone, the MCS 262 sends an INVITE message to the IPLR 130. In some situations that are described further below, the IPLR 130 may return a REDIRECT message identifying another destination on the Internet, for example, an address of a VoIP telephone. In the scenario described above in which a SIP INVITE to a mobile subscriber is sent to the IPLR, the IPLR returns a REDIRECT message identifying a telephone number on the PSTN, specifically the TLDN at the serving MSC 126 for the subscriber. In order to complete such a call, the MCS 262 instructs a media gateway 266 to construct an outbound circuit-switched call to the telephone number. When and if that telephone number answers, the MCS 262 causes the original VoIP caller to connect to the media gateway 266 which completes the voice circuit from the caller to the telephone.

Another capability of enabled by the IPLR 130, in concert with the PSTN-VoIP gateway 260, is redirection of a call placed to a mobile subscriber's telephone number to a VoIP phone. For example, the call can be redirected to a fixed VoIP phone 112. Also, in the case of a mobile telephone being a dual mode device that can have a presence as a mobile phone 110 on a VoIP access network (e.g., a wireless LAN coupled to the Internet), the redirection can be to the user's phone through the data network rather than through the mobile telephone network.

When a call is made to a user's mobile telephone number, for example, from a telephone 142 on the PSTN 140, the PSTN launches an Initial Address Message (LAM) to the user's home MSC 122. In this scenario, a VLR function 232 in the IPLR has previously informed the HLR 121 that the subscriber is being served by that VLR, for example, as a result of a dynamic registration of the mobile telephone 110 over a VoIP access network to the IPLR 130. Upon receiving the IAM message from the PSTN, the MSC 122 sends a Location Request to the HLR 121. The HLR 121 then sends a Route Request to the VLR function 232 of the IPLR 130 through the SS7 interface 236 of the IPLR. The IPLR 130 consults the URI-MIN table 234 to determine the URI associated with the number being called. The IPLR 130 determines a TLDN of the media gateway 266 to which the call will be forwarded. For example, the IPLR 130 may request the TLDN from the media gateway 266, or the IPLR may manage a range of TLDNs of the gateway. The VLR function 232 returns the TLDN of the gateway to the HLR 121, which returns it to the MSC 122, which returns it to the PSTN in response to the IAM message.

Based on the response to the IAM message, the PSTN routes the call to the TLDN of the media gateway 266. In order to determine where on the data network to route the VoIP call, the gateway 266, via the MCS 262, sends a SIP INVITE message to the IPLR 130 identifying the TLDN. The IPLR has kept track of the TLDN it provided to the HLR, and therefore is able to determine which MIN or URI is associated with that TLDN. For example, the URI-MIN table 234 can include an additional field for the TLDNs associated with the MIN-URI pairs. After determining the URI to which that call should be forwarded, the IPLR 130 responds to the INVITE message with a REDIRECT message identifying the address of the VoIP phone to which the call should be connected. The MSC receives the REDIRECT message and sends an INVITE to the indicated address to complete the call. A voice circuit is thereby set up from the PSTN 140 via the media gateway 266 over the data network the VoIP phone 112.

An application of the IPLR 130 capabilities, described above, is to provide concurrent ringing of a user's mobile telephone (where present on the mobile network or in a private network domain) and a fixed VoIP telephone 112. In one version of this capability, the user's fixed VoIP telephone 112 is the primary number that is called, while in another version, it is the user's mobile number that serves as the primary number that is called, while in yet another version calling either number causes both phones to ring. In general, the function of forking the call to both the user's mobile device and VoIP phone is handled by the MCS 262.

A number of preconditions or other assumptions are applicable to a first usage example described below. The subscriber is assumed to have configured the IPLR 130 and the PSTN-VoIP gateway 260 to simultaneously ring both the subscriber's VoIP phone 112 and his mobile phone 110 when a caller dials the subscriber's wireline number. For example, such configuration could be accomplished using a browser-based UI capable of provisioning both systems. The VoIP phone 112 is currently registered with the MCS 262. The mobile phone 110 is registered with a serving MSC 126 in the mobile network (note that it is not registered with the VLR function 232 of the IPLR 130 in this usage example). The IPLR uses the softswitch 264 and media gateway 266 for circuit to packet conversion. The mobile network 120 contains no media gateways.

The messages passed between components in this usage example include the following:

1. A caller at a telephone 142 dials the subscriber's wireline VoIP number. The PSTN 140 launches an ISUP Initial Address Message (IAM) to the gateway 266. The gateway 266 sends a SIP INVITE message to the softswitch 264 that contains the called party id.

2. The softswitch 264 sends a SIP message (or Megaco message) to the MCS 262 that contains the URI of the called party (e.g., SIP:Invite:CalledPartyID@Carrier.com).

3. The MCS 262 launches an Invite to the IP address of the VoIP Phone 112 using the same URI. The IP phone begins to ring and returns the SIP informational Ringing message.

4. The MCS 262 “forks” the SIP invite to IPLR 130. That is, it launches a second INVITE to the IP address of the IPLR. Since the IPLR's IP address is resolved using DNS prior to the INVITE, any of a set of possible IPLRs may receive the INVITE depending on the DNS resolution, so a wireline number is not necessarily tied to a “home” IPLR.

5. The IPLR 130 maps the URI (e.g., CalledParty@Carrier.com) to a Mobile ID Number (MIN) and launches a Location Request to the HLR 121. Note that the IPLR is also capable of acting as a “home” MSC from the perspective of the mobile network. The HLR 121 sends Route Request to the currently serving MSC 126 and the MSC 126 returns a temporary local directory number (TLDN). The HLR 124 forwards the TLDN to the IPLR in the LocReq return results.

6. The IPLR 130 responds to the MCS's INVITE by sending a 302 REDIRECT message that contains the TLDN. Alternatively, other messages may be used to accomplish what is effectively a call forward.

7. The MCS 262 instructs the Gateway 266 to create an outbound circuit-switched call to the TLDN. The Gateway sends an ISUP IAM message to the serving MSC that contains the TLDN.

8. The serving MSC 126 processes the call to its TLDN using conventional procedures and alerts then rings the mobile phone 110. Now both the VoIP phone 112 and the mobile phone 110 are ringing. Whichever phone answers first will receive the call.

9. In this use case, the VoIP phone 112 answers first by sending 200 OK to the MCS. The MCS 262 and Gateway 266 establish the RTP path to the VoIP phone 112 and the conversation begins. The MCS generates the call detail records for this call.

10. The Gateway 266 sends an ISUP Disconnect message to the serving MSC and the mobile phone 110 stops ringing. In the event neither phone answers, the caller is redirected to the voice mail system of the subscriber's choice, preconfigured via system administration procedures.

11 Case 7

Referring again to FIG. 1, some examples of a wireline prime service involve coupling a gateway NCG 182 and the terminal (as opposed to the network) side of the voice server 154.

Although this example is similar to the previously described example in which the network side of the voice server 154 communicates with the gateway NCG 182, communication via the terminal side changes the nature of the interface between the SIP-based voice server 154 and the SIP-based gateway NCG 182 by having the gateway NCG 182 emulate multiple SIP-based terminals, typically one for each subscriber, as it is connected to the voice server 154. The voice server 154 may require active SIP registrations for each emulated terminal, or it may be sufficient for it to setup passive, static registrations for each terminal.

For the voice server 154, an emulated terminal can be associated with a particular wireline subscriber, who just happens to be mobile-connected at a mobile terminal 110 via the gateway NCG 182. In addition, directly connected SIP terminals 112 can also be associated with the same wireline subscriber, using the “multiple appearances” feature. This means that calls for that wireline subscriber can be directed by the voice server to both appearances, either simultaneously or sequentially. In this way, the subscriber can be reached either via a directly-connected SIP terminal or via a mobile-connected handset.

Note that an inbound calls in this example follows two paths. First path passes from the terminal side of the voice server 154 to the SIP terminal 112. The second path passes from the terminal side of the voice server 154, over the VoIP access network 156 to gateway NCG 182, through the media gateways to the mobile backbone 120 to the serving MSC 126 and then to the mobile telephone 110. An example of the second path is shown with a broken line in FIG. 1 joining the voice server 154 and a mobile telephone 110 registered with a serving MSC 126. Similarly, another example related to the second path joins the voice server 154 and a VoIP telephone 112 registered with a serving NCG 184, also illustrated with a broken line in FIG. 1.

When the SIP-based gateway NCG 182 receives a call from voice server 154, the Called Number may be the wireline DN for the subscriber or the private dialing plan extension assigned to the subscriber. In either case, the gateway NCG 182 translates the number into the MDN/MSISDN assigned to the subscriber. In another option, the voice server 154 may pre-translate, for example using a stored table of translations, the wireline DN to the subscriber's MDN/MSISDN, and forward the Called Number along with the MDN/MSISDN to the NCG 182.An exemplary series of steps for this example are outlined below:

Step 1: Calls intended for the subscriber wireline directory number (for example from the PSTN) are routed by voice server 154 to the terminal or terminals associated with that subscriber following the rules configured for these terminals with the “multiple appearance” feature. For example, the rule for a subscriber is set for simultaneous ring of two terminals (appearances), where one terminal is the directly connected SIP phone terminal 112, and the second terminal is an “emulated terminal” , for example associated with a mobile terminal 110 on the mobile telephone radio network, provided by the gateway NCG 182. The call is to be connected to the first terminal that replies with a SIP CONNECT message.

Step 2: When gateway NCG 182 receives the call from voice server 154, the Called Number is the wireline DN for the subscriber or the private dialing plan extension assigned to the subscriber. In either case, the gateway NCG 182 translates the number into the MDN/MSISDN assigned to the subscriber. When the gateway NCG 182 receives a private dialing plan extension from voice server 154, it uses the “Tenant” to properly interpret the extension and assign the correct MDN/MSISDN. This can typically be done given that the gateway NCG 182 knows that a particular call is coming from the IP address of voice server 154, and that voice server 154 can optionally add a unique prefix for each tenant. Optionally, the voice server 154 may pre-translate the Wireline DN to the subscriber's MDN/MSISDN, and forward the MDN/MSISDN to the gateway NCG 182.

Step 2b: The gateway NCG 182 then tries to complete the call to the mobile subscriber's handset 110, assuming that they are currently registered. The gateway NCG 182 first sends a Location request to the HLR, which then returns the last known location of the subscriber at a serving MSC 126. The gateway NCG 182 then sends a Route request to the serving MSC 126. Assuming the subscriber is currently registered, the serving MSC 126 returns a TLDN/MSRN to the gateway NCG 182.

Step 3: The gateway NCG 182 then routes the call via the mobile backbone 120 using the TLDN/MSRN to the serving MSC 126, which then completes the call to the subscriber's mobile telephone 110.

Step 2c: When the called subscriber is no longer registered on the mobile network, and gateway NCG 182 checks with the HLR, it typically finds that there is no current registration. In some cases, it may find a pointer to a serving MSC 126 where the subscriber was last registered, but when it sends a Route request to that serving MSC 126, it finds that the subscriber is no longer registered. In either case, the gateway NCG 182 releases the call back to voice server 154, irrespective of the subscriber's profile within the HLR.

Step 3b: In a third case, Gateway NCG 182 finds that the subscriber is still registered to MSC 4 and routes the call there using the TLDN/MSRN, but the call doesn't complete because the subscriber rejects the call, is busy, or does not answer. Again the call is released back to voice server 154.

In an IS41-based mobile network, the gateway NCG 182 provides the call treatment based upon a reason code received from the serving MSC 126 and it can release the call back to voice server 154 irrespective of the subscriber's profile within the HLR. Thus, in an IS-41 network, this wireline prime service can be provided to the subscriber at the same time as a basic mobile service.

In a GSM-based mobile network, the serving MSC 126 provides the call treatment based on the subscriber's profile obtained from the HLR. To release the call in this situation, the subscriber's profile in the HLR is set to provide no call treatment, and thus this wireline prime service cannot, in general, be provided to the subscriber at the same time as a basic mobile service. To release the call in this situation and still preserve the ability to provide basic mobile services, each serving MSC can be arranged with a terminating trigger that recognizes calls from the gateway NCG 182 and then provides a simple release if the call cannot be completed.

Step 5: If voice server 154 sees that the call has been released prior to connect, it routes the original call to the following the rules configured for the connected terminals with the “multiple appearance” feature. Typically, if there is no answer, the call is finally routed to a voice mail system 148 or 157 associated with the subscriber's wireline directory number.

Note that because a connected subscriber on mobile handset terminal 110 is connected to the terminal side of the voice server 154, it is possible for the subscriber to access supplementary features in voice server 154 using various mechanism that are described in the following sections.

12 Case 7b

In some examples related to those described above, a subscribed can access an inbound mid-call call waiting feature with multiple calls. Assume that the subscriber is using mobile handset 110 connected via the gateway NCG 182 to the voice server 154 to talk on an originally wireline call delivered by the voice server 154. An exemplary series of steps for this example are outlined below:

Step 1: If there is a second inbound call during mid-call, the voice server 154 responds by forwarding an Invite message to the emulated SIP terminal provided by gateway NCG 182.

Step 2: The gateway NCG 182 extends the second call into the mobile network, where it is routed (like the first call) via a TLDN/MSRN to the serving MSC 126 for connection to mobile telephone 110.

Step 3: Since the mobile telephone 110 is connected via a mobile radio to the serving MSC 126, it is limited to one media stream and one active call. Thus, when a second call is routed to the serving MSC 126 intended for the subscriber, the serving MSC 126 uses signaling messages to inform the subscriber that a second call is waiting.

Step 4: The subscriber signals serving MSC via messages if they want to hold the first call and accept the second call, or simply reject the second call. If the subscriber accepts the second call, the serving MSC can put the first call on hold, or handle both the first and second calls simultaneously.

In this manner, the inbound call waiting feature is provided in a straightforward manner, that fully utilizes the native capabilities of voice server 154 and the serving MSC 126.

13 Case 7c

In some examples related to those described above, a subscribed can access an outbound mid-call transfer or conference feature. Assume that the subscriber is using mobile handset 110 connected via the gateway NCG 182 to talk on an originally wireline call delivered by SIP-based voice server 154. An exemplary series of steps for this example are outlined below:

Step 1: An example of a trigger for an outbound call features occur when the subscriber chooses to transfer the call, or chooses to add a third-party to the call. In either case, the subscriber establishes a second call and merges it with the first call. Given that voice server 154 and the gateway NCG 182 are both SIP-based, this can be entirely accomplished within the gateway NCG 182, including setting up a second call and merging the media entirely within the gateway NCG 182.

Step 2: To request such a mid-call feature, the subscriber using mobile handset 110 quickly and reliably signals to gateway NCG 182. Note that in this example, this is possible when the mobile handset registered to any mobile network, whether home or visited. The request can be done with DTMF digits, sent mid-call from the mobile handset and received by gateway NCG 182. Since gateway NCG 182 operates in a SIP-based VoIP environment, it typically receives DTMF digits as RFC 2833 messages in the RTP media stream.

Step 2b: Upon receipt of DTMF digits, the gateway NCG 182 traps them, interprets them, decides that a particular mid-call feature is being requested, and then provides the appropriate mid-call feature sometimes establishing and manipulating a second call through voice server 154.

Step 2c: Upon receipt of DTMF digits, the gateway NCG 182 traps them, interprets them, and decides that a mid-call feature is not being requested. In this case, it re-inserts the DTMF digits towards the voice server 154, typically by inserting RFC 2833 messages into the RTP media stream.

14 Case 7d

In some examples there are mid-call features that are to be provided entirely within voice server 154. These are typically initiated from a connected terminal using a “Switch hook flash” action, or the equivalent in a special SIP message. A switch hook flash approach may be required when the terminal and voice server are not based on SIP, but it is also used, in some cases, where both terminal and the voice server are SIP-based.

In this example, we assume that there is a directly connected terminal such as terminal 112 directly connected to the voice server 154. Typically, the subscriber using the terminal 112 would send a first switch hook flash (or equivalent special SIP message) and voice server 154 would then put the first call on hold, be ready to accept DTMF digits to signal the feature desired (often a *xx code), and possibly to setup a second call.

One outbound example is to have voice server 154 add a third party to the call. Typically, the subscriber would send a first switch hook flash (or equivalent special SIP message) and voice server 154 would then put the first call on hold, and be ready to accept DTMF digits to setup a second call. Then, after the second call is established, the subscriber would send a second “Switch hook flash” (or equivalent special SIP message) and voice server 154 would merge the first call into this second call.

One inbound example is to have voice server 154 handle a call waiting entirely within voice server 154. In this case, it would notify the Subscriber with a beep-tone and the subscriber would respond using a switch hook flash (or equivalent special SIP message. Then, upon receipt of a switch hook flash action the voice server 154 puts the first call on hold and extends the second call to the terminal 112. Upon receipt of a second switch hook flash the voice server 154 returns to the first call and puts the second call on hold.

To activate and manage mid-call features from a subscriber connected using a mobile handset 110, a switch-hook flash action is enabled to signal from the handset followed by DTMF digits to signal the feature desired (often a *xx code), and possibly to setup a second call. An exemplary series of steps for this example are outlined below. Assume that the subscriber is using mobile handset 110 connected via the gateway NCG 182 to talk on an originally wireline call delivered by SIP-based voice server 154.

Step 1: To activate or manage a mid-call feature, the subscriber using mobile handset 110 sends DTMF digits mid-call to indicate that a “switch-hook flash” action is required, which is optionally followed by a *xx code. For example, the digits sent could be ** to indicate a “switch-hook flash action”, followed by *xx to select the feature, and possibly 12345# to dial a second extension.

Step 2: Since the gateway NCG 182 operates in a SIP-based VoIP environment, it will typically receive DTMF digits as RFC 2833 messages in the RTP media stream. Upon receipt of DTMF digits, the gateway NCG 182 traps them, interprets them, decides that a particular mid-call feature is being requested, and then provides or emulates the appropriate signaling to voice server 154. For example, ** could be interpreted as a “switch-hook flash” action, and that could be indicated to voice server 154 using a specialized SIP message. The remaining DTMF digits might be re-inserted for the voice server 154 to interpret them.

Step 2b: Note that the terminal being emulated might follow a protocol other than SIP, such as MGCP. Then, the “switch hook flash” action and the following digits are interpreted into the equivalent MGCP messages and forwarded to the voice server 154.

Step 2c: Upon receipt of DTMF digits, the gateway NCG 182 traps them, interprets them, and decides that a mid-call feature is not being requested. In this case, it re-inserts the DTMF digits towards the voice server 154, typically by inserting RFC 2833 messages into the RTP media stream.

15 Case 8

In examples described above, in general, the serving NCG 184 is illustrated as separate from the gateway NCG 182. In some examples, these elements can be implemented as one NCG that serves both functions. In some examples, these elements are separate, but are coupled over an IP network allowing calls to be passed directly between then without having to pass over the mobile backbone 120. In some examples, the serving NCG 184 is associated with and optionally hosted at a specific enterprise to provide telephone connectivity for subscribers in that enterprise.

In an example in which the serving NCG 184 is coupled to the gateway NCG 182 over an IP network (e.g., over the public Internet, over a portion of the VoIP backbone 150, or over a private IP network) operation is similar to that described for Case 7 above in the situation in which the subscriber is registered at a dual mode telephone 110 or a IP telephone 112 coupled through the VoIP access network 186 to the serving NCG 184. Note that calls are routed according to a TLDN/MSRN to the serving NCG 184, but these calls remain entirely within the VoIP domain.

Note that an inbound calls in this the example follows two paths. The first path is from the terminal side of voice server 154 to an IP telephone 112, while the second path is from the terminal side of voice server 154, over the VoIP Access network 156 to the gateway NCG 182, to the serving NCG 184 for example over the VoIP backbone 150, and from the serving NCG 184 to an IP telephone 112 or dual mode telephone 110 registered with the serving NCG 184.

In this case, the gateway NCG 182 operates in the same manner as in Case 7, since a connected subscriber on a mobile telephone 110 on the mobile radio network is still be able to access supplementary features, as presented in Cases 7b, 7c and 7d. A connected subscriber using dual mode telephone 110 registered with the serving NCG 184 is able to access supplementary features, as presented in Case 7d, using DTMF digits to activate and manage the features.

16 Case 8b

In examples in which the gateway NCG 182 and serving NGC 184 are coupled over a VoIP path, or in which they reside on one NCG that provides both functions, inbound mid-call call waiting features with multiple calls are extended to subscribers on telephones 112 and 110 registered with the serving NCG 184.

For example, in a call in which the subscriber is using a WiFi-connected handset 110 connected via the gateway NCG 182, to talk on an wireline call delivered by SIP-based voice server 154, the following are exemplary steps in such a call:

Step 1: If there is a second inbound call during mid-call, SIP-based voice server 154 respond by forwarding an invite message to the emulated SIP terminal provided by gateway NCG 182.

Step 2: Then, gateway NCG 182 extends the second call into the mobile network, where it will be routed (like the first call) via a TLDN/MSRN to the serving NCG 184, for connection to the terminal 110. An alternative is to route the call directly between the Gateway NCG 182 and the Serving NCG 184.

Step 3: Since SIP-Signaling is used between the serving NCG 184 and the WIFI-connected terminal 110, if an additional call is routed to the serving NCG 184 that is intended for the terminal 110, a SIP Invite is then extended from the serving NCG 184 to the terminal 110, even though the subscriber is currently engaged in an active call (or session).

Step 4: The terminal 110 then indicates to the subscriber that another call (session) is pending and the subscriber can then choose to accept or reject the call using the terminal. If the subscriber accepts the second call, they may place the first call on hold or the terminal may support two active calls, simultaneously. In a similar manner, even another call could be added, assuming the terminal could support three or more simultaneous calls.

In this manner, the inbound call waiting feature is extended fully utilizing the native capabilities of the voice server 154, the gateway NCG 182, the serving NCG 184 and terminal 110 to extend multiple calls (sessions) all the way to the subscriber's terminal.

17 Case 8c

In another example, outbound mid-call transfer or conference features are provided to a subscriber on an IP-based terminal registered with the serving NCG 184. In this example, the subscriber is using mobile handset 110, connected via the serving NCG 184 and the gateway NCG 182, to talk on an originally wireline call delivered by SIP-based voice server 154.

An example of a trigger for an outbound call feature occurs when the subscriber chooses to transfer the call, or chooses to add a third-party to the call. In such cases, the subscriber establishes a second call and merges it with the first call.

In one approach, multiple calls are set up all the way to the terminal 110, and then combined there. An alternative that may result in reduced delays for the RTP media flows, and reduction in associated signal degradation is to provide these features entirely within gateway NCG 182, following Case 7c, or even entirely within voice server 154, following Case 7d, as described above.

18 Case 8d

In some examples, the gateway NCG 182 knows that it has terminated a call via the serving NCG 184 to a SIP-based terminal 112 or 110 rather than over a serving MSC 126 to a terminal 110 over the mobile radio network. In such examples, both the serving NCG 184 and the gateway NCG 184 can switch to proxying the SIP signaling directly from the terminal 112 or 110 to the voice server 154 allowing SIP messages to effectively flow directly between the terminal 112 or 110 and voice server 154.

Thus, in such examples of a wireline prime service, a subscriber on a VoIP terminal (e.g., a dual mode handset 110 or a VoIP phone 112 registered with the serving NCG 184) that is registered on the mobile network is not just effectively connected to the wireline voice server 154, but is actually directly (through proxies) connected to the server. This allows a range of services that is essentially only limited by the voice server's capabilities. In such examples, services other than basic voice services may be extended from the voice server 154 to SIP terminals 112 and 110. For example, Call Park, Call Transfer, Call Forwarding, Multiparty Conferencing, Messaging (e.g. SMS or MMS), Presence, and Video, can be extended via SIP from the voice server 154 to SIP terminals 112 and 110.

19 Case 9

In some examples, subscribers on mobile telephones 110 or registered with a serving NCG 184 on dual mode telephones 110 or SIP telephones 112 can place inbound calls using the dialing plan and features of the wireline voice server 154. To accomplish this, all serving MSCs 126 and all serving NCGs 184 are equipped with a feature, such as an inbound trigger, to cause all calls that are to be handled by the wireline voice server 154 to be directly routed to gateway NCG 182, which would in turn deliver such calls to the terminal side of the SIP-based voice server 154. These triggers can implemented using CAMEL (GSM) or WIN (CDMA) intelligent network protocols and can be realized with a Service Control Point (SCP). This SCP can, for example, be implemented in the gateway NCG 182. Once the subscriber is connected to the terminal side of the SIP-based wireline voice server 154, all supplementary services, including mid-call features, should be available on inbound calls using exactly the same mechanisms as described in Cases 7 and 8 for outbound calls.

20 Mobile PBX

In some examples, a new network element, a mobile PBX SCP 122, is introduced to support a “Mobile PBX Service”. Different network protocols and interfaces can be used by this new network element to implement the Mobile PBX Service for different mobile networks. In mobile networks based on GSM, for example, the service will be supported by a “Mobile PBX Service” Service Control Point (SCP) based on IN (Intelligent Networking) and CAMEL (Customized Applications for Mobile network Enhanced Logic). In these examples, the gateway NCG 182 acts as the gateway between the mobile network and a voice server 154, which may be an enterprise IP PBX.

Using the GSM network as an example, CAMEL Subscription Information for Mobile Originated Calls (O-CSI) is provisioned in the HLR 121. When the subscriber's mobile phone 110 registers with the GSM network, the HLR 121 pushes the O-CSI to the serving MSC 126.

The O-CSI is provisioned such that all outgoing calls made from a user's mobile phone trigger a CAMEL dialog with the Mobile PBX Service SCP 122 from the serving MSC 126. This is done using the CAMEL_Initial_DP message. During the initiation of this CAMEL dialog, the digits dialed by the user on the mobile phone 110 (i.e., Called Party Number) are provided by the MSC to the SCP.

The SCP 122 analyzes the caller's CSI to identify the subscriber's enterprise (and therefore identify the enterprise's voice server 154) and the gateway NCG 182 serving as a gateway to the voice server (e.g., if there are multiple gateway NCGs 182 on the mobile network). The SCP 122 interacts with the gateway NCG 182 to provide the NCG with the dialed digits and to obtain from the NCG a Routing Number. The NCG stores the dialed digits and maintains an association between the Routing Number it provides and the dialed digits. This interaction between the SCP and the gateway NCG can use proprietary protocols.

The SCP 122 then responds to the serving MSC CAMEL dialog initiation by instructing the serving MSC 126 to route the call to the Routing Number provided by the NCG, using the CAMEL_CONNECT message.

The serving MSC then routes the call to the gateway NCG using ISUP IAM.

Based on the Routing Number, the NCG retrieves the subscriber's original dialed digits, and initiates a SIP Invite to the terminal side of the voice server 154 using the subscriber's original dialed digits. The gateway NCG 182 acts as a SIP User Agent (i.e., acting as a desktop IP PBX extension phone) towards the voice server 154. The gateway NCG 182 behaves in such a way that the voice server 154 does not distinguish whether the SIP Invite is coming from a desktop IP PBX extension phone 112 on the access network 156 or from other devices not directly connected to the access network.

The voice server 154 handles the call (e.g., the SIP Invite) from this point on. For example, if the subscriber's original dialed digits were the extension number of another IP PBX extension 112, the voice server 154 routes the call (SIP Invite) to the appropriate extension phone.

Since calls initiated from the mobile (GSM) phone 110 are identical to calls initiated from a company IP PBX extension phones 112, the Mobile PBX Service provides the same end user experience whether the user is using a desktop IP PBX extension phone or a cellular (GSM) phone.

Optionally, the system supports a method by which a subscriber on a mobile telephone 110 can toggle between the a “PBX Mode” of operations where all calls made from his cellular phone are routed and handled by the voice server 154, and a “GSM Mode” where calls from his mobile telephone are routed and handled directly by the mobile network network.

In some examples of a mobile PBX, calls placed to the mobile DN that are routed in the mobile network destined for the Mobile DN are sent to the voice server 154 via the gateway NCG 182. This routing can be done using a variation of the arrangement described above whereby the gateway MSCs have terminating triggers, and there is a SCP, which may be in contact with the gateway NCG 182 where it gets a TLDN/MSRN.

21 Mobile Prime

In some examples, calls made to a subscriber's mobile telephone are redirected to a VoIP telephone using the IPLR 130, which was described above. Referring to FIG. 2, a capability enabled by the IPLR 130, in concert with the PSTN-VoIP gateway 260, is redirection of a call placed to a mobile subscriber's telephone number to a VoIP phone, such as a telephone 112. Also, in the case of a mobile telephone 110 being a dual mode device that can have a presence on the mobile telephone radio network as well as on via a serving NCG 184 (see FIG. 1), the redirection can be to the user's phone through the data network rather than through the mobile telephone network.

When a call is made to a user's mobile telephone number, for example, from a telephone 142 on the PSTN 140, the PSTN launches an Initial Address Message (IAM) to the gateway MSC 124. In this scenario, the VLR function 232 in the IPLR 130 has previously informed the HLR 121 that the subscriber is being served by that VLR, for example, as a result of a dynamic registration of a VoIP phone 112 via a voice server 154. Upon receiving the IAM message from the PSTN, the home MSC 122 sends a Location Request to the HLR 121. The HLR 121 then sends a Route Request to the VLR function 232 of the IPLR 130 through the SS7 interface 236 of the IPLR. The IPLR 130 consults its URI-MIN table 234 to determine the URI associated with the number being called. The IPLR 130 determines a TLDN of the media gateway 266 to which the call will be forwarded. For example, the IPLR 130 may request the TLDN from the gateway, or the IPLR may manage a range of TLDNs of the gateway. The VLR function 232 returns the TLDN of the gateway to the HLR 121, which returns it to the home MSC 122, which returns it to the PSTN in response to the IAM message.

Based on the response to the IAM message, the PSTN routes the call to the TLDN of the media gateway 266. In order to determine where on the data network to route the VoIP call, the gateway 266, via the MCS 262, sends a SIP INVITE message to the IPLR 130 identifying the TLDN. The IPLR has kept track of the TLDN it provided to the HLR, and therefore is able to determine which MIN or URI is associated with that TLDN. For example, the URI-MIN table 234 can include an additional field for the TLDNs associated with the MIN-URI pairs. After determining the URI to which that call should be forwarded, the IPLR 130 responds to the INVITE message with a REDIRECT message identifying the address of the VoIP phone to which the call should be connected. The MSC receives the REDIRECT message and sends an INVITE to the indicated address to complete the call. A voice circuit is thereby set up from the PSTN 140 via the media gateway 266 over the data network, to the VoIP phone 112.

An application of the IPLR 130 capabilities, described above, is to provide concurrent ringing of a user's mobile telephone (where present on the mobile network or in a private network domain) and a fixed VoIP telephone 174. In one version of this capability, the user's fixed VoIP telephone 174 is the primary number that is called, while in another version, it is the user's mobile number that serves as the primary number that is called, while in yet another version calling either number causes both phones to ring. In general, the function of forking the call to both the user's mobile device and VoIP phone is handled by the MCS 262.

An exemplary sequence of messages for this example includes the following:

1. A caller (e.g., from telephone 142 on PSTN 140) dials the MIN of a mobile subscriber. The PSTN 140 launches an ISUP IPAM message to the home MSC 122 that contains the MIN.

2. The MSC 122 launches Location Request to the HLR 121. The HLR, by virtue of IPLR's previous registration, sends a Route Request to the VLR function 232 of IPLR 130 that contains the MIN.

3. The IPLR assigns a TLDN that is associated with the Gateway 266 and returns it to the HLR. The HLR forwards the TLDN to the home MSC in the locreq return result.

4. The home MSC 122 sends an ISUP circuit switched call to the gateway 266 and softswitch 264. The softswitch (or gateway) sends the IPLR a SIP INVITE (SIP:Invite:TLDN@Carrier.com).

5. The IPLR maps the TLDN to the MIN that it received in the RouteReq and launches a SIP:Invite: MIN@Carrier.com to the IP address of the mobile telephone 110 in the private data network domain. The mobile telephone 110 returns 180 Ringing.

6. The IPLR 130 maps the MIN to the associated VoIP telephone 112 and “forks” the SIP Invite to the MCS using the URI WirelineNumber@Carrier.com. The MCS 262 launches an Invite to the VoIP Phone 112 and the IPP phone returns 180 Ringing. Both the mobile telephone 110 and the VoIP phone 112 are now ringing. The first phone to answer gets the call.

7. In this case, the mobile phone 110 answers first. The IPLR 130 sets up the RTP path between the mobile telephone 110 and gateway 266 and the conversation begins. The IPLR creates call detail records for this call.

8. The IPLR sends the MCS a SIP:Cancel message (or equivalent) to stop the attempt to establish a session with the IP phone 112, which the MCS sends to the VoIP phone.

The some versions of the system MCS can be divided into various pieces in a similar manner to the IP Multimedia Subsystem (IMS) concept of a separate P-CSCF and S-CSCF. The MCS can also have at least some capabilities that the IPLR doesn't have, such as support of TAPI-like interfaces to PBXs. The MCS can function as a SIP Registrar that has extensions and APIs to OSA/Parlay servers, OAMP, provisioning and back-office systems. The MCS does not have to have direct connectivity to mobile networks.

In another example of a mobile prime approach, the IPLR element is not used. For example, when a mobile telephone 110 registers on the mobile network with the HLR 121, the HLR updates the serving MSC 126 with a trigger, such as a CAMEL trigger. When a telephone 110 places a call, the trigger causes the serving MSC 126 to query and SCP function, which may be in hosted as a separate element or may be hosted in the gateway NCG 182. The gateway NCG 182 converts the signaling from the MSC 126 into the SIP protocol and communicates with the voice server 154, which acts as an IP PBX or an IP Centrex. The voice server 154 interprets the dialed number to determine where to forward the call and may apply other call treatments. In this example, the gateway NCG 182 has a SIP interface to the voice server and makes the mobile phones on the mobile network appear to be SIP devices attached to the voice server. In a usage example, the one mobile telephone 110 is calling another mobile telephone 110 using a private dialing plan, for example, by dialing a three-digit extension. In this usage example, the voice server 154 uses SIP messaging to route the call back to the NCG 182. The NCG 182 then queries the HLR 121 to determine where to route the call. Based on the information from the HLR, the NCG routes the call to the serving MSC 126 that is serving the destination telephone 110.

In another usage example, the originating telephone 110 places a call to a telephone number prefixed by a number indicating that this is a PSTN number. For example, the caller dialed a 9 followed by a 10-digit telephone number. In this case, the voice server 154 again receives the SIP signaling information for the call, and determines that a PSTN call is to be made to the 10-digit number. In this usage example, the call is routed from the serving MSC 126 to the gateway MSC 182, and then as a VoIP call to the voice server 154. The voice server completes the call to the PSTN, for example via the PSTN-VoIP gateway 160 or using a direct PSTN connection (not shown in FIG. 1).

In another usage example, a caller on the PSTN places a call to a mobile telephone 110. When the telephone 110 registered with the HLR 121, the HLR set up a trigger in the gateway MSC 124. When the gateway MSC 124 receives the call from the PSTN, it queries the SCP function hosted in the gateway NCG 182, which uses SIP signaling to communicate with the voice server 154 to determine how to complete the call. The voice server 154 passes the call back to the gateway NCG 182, which queries the HLR to determine which serving MSC 126 is handing the telephone 110. The call is then completed from the gateway MSC 124 to the telephone's serving MSC 126.

In some examples in which the gateway NCG 182 provides a conversion from a circuit based call to a VoIP call, the gateway NCG also performs signal detection, such as DTMF detection, during a call can coverts the detected signals into packet-based signals. In another implementation, these mid-call DTMF signals can be converted to CAMEL or WIN messages by the Serving MSC 126 and then delivered to the Gateway NCG 182 as CAMEL or WIN messages. For example, such packet-based signals are passed to the voice server 154 to invoke mid-call features.

In some examples in which a user's unanswered or rejected calls are passed to a voice mail system, such as a PSTN based voice mail system 138, or voice mail system associated with a voice server 154, which may be a premised or central IP PBX of IP Centrex server, call pass to a single voice mail system regardless of where the call originated and on which network the user was present. A “message waiting” indicator is extended so that it is provided to the user regardless of the network on which he is registered. For example, in the case of a mobile prime system in which the user's messages pass to the voice mail system 157 associated with the voice server 154, a message waiting light is provided on the user's VoIP telephone 112 as well as on the user's mobile telephone 110 registered on the mobile network. Further, using a mobile prime approach, the user can retrieve the waiting messages in voice mail system 157, for example, via the voice server 154.

Other forms of mobile registration of a telephone 110 in a private network domain (e.g., on VoIP access network 186) can be used. For example, rather than using a dual mode mobile telephone and IPP phone, a mobile phone may have other wireless capabilities, such as Bluetooth, via which it registers and communicates with the IPLR. Furthermore, it should be evident that the approach described above is applicable without providing the capability of a mobile phone having dual identities for a mobile telephone and a packet-based network.

Alternative versions of the system can be implemented in software, in firmware, in digital electronic circuitry, or in computer hardware, or in combinations of them. The system can include a computer program product tangibly embodied in a machine-readable storage device for execution by a programmable processor or a computer program embodied on a carrier signal propagated over a medium for example over a data communication network, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A method for providing telecommunication services comprising:
accepting at a first element a signal indicative of a call to a subscriber at an address on a fixed network; and
extending the call to a second terminal registered on a mobile telephone network via a packet-based data network, including receiving a signal indicative of the call at a second element coupled to the mobile telephone network and to the packet-based data network, and routing the call to the terminal based on routing information available to the second element.

2. The method of claim 1 wherein the address on the fixed network comprises a wireline telephone number.

3. The method of claim 1 wherein the address on the fixed network comprises a VoIP network address.

4. The method of claim 1 wherein the first element comprises a switch.

5. The method of claim 1 wherein the first element comprises a packet-based voice server.

6. The method of claim 1 further comprising:
determining at the first element whether to route the call to a first terminal associated with the address on the fixed network and/or to the second terminal registered on the mobile network.

7. The method of claim 1 further comprising:
if the call is not completed to the second terminal on the mobile telephone network, handling the call in the same manner as if the call were note completed to a first terminal associated with the address on the fixed network.

8. The method of claim 7 wherein handling the call comprises routing the call to a message server on the fixed network.

9. The method of claim 1 wherein extending the call comprising:
providing communication services to the second terminal by emulating corresponding packet-based voice terminal by the second element in communication with the first element.

10. The method of claim 1 further comprising:
providing call features using the first element to a subscriber at the second terminal.

11. The method of claim 10 wherein providing call features comprising providing mid-call features.

12. The method of claim 1 wherein extending the call to the second terminal further comprises obtaining the routing information at the second element from the mobile network.

13. The method of claim 1 further comprising:
providing outbound calling features from the second terminal registered on the mobile network via the first element.

14. The method of claim 13 wherein the outbound calling features include a private dialing plan feature.

15. A method for providing private telephone features at terminals registered on a mobile telephone network comprising:
providing a first element configured to provide private telephone features;
providing a second element coupled to the mobile telephone network and coupled over a packet-based data network to the first element; and
processing a call placed between a first terminal registered on the mobile telephone network and another terminal, including passing signaling information for the call between the first element and the second element.

16. The method of claim 15 wherein the call placed between the first terminal and the other terminal comprises one of: a call placed from the first terminal and a call placed to mobile telephone number associated with the first terminal.

17. The method of claim 15 wherein passing signaling information for the call between the first element and the second element comprises passing a routing request from the second element to the first element.

18. The method of claim 17 wherein passing the routing request comprises passing a dialed number in a private dialing plan.

19. The method of claim 15 wherein passing signaling information for the call between the first element and the second element comprises passing a mid-call feature request initiated at the first terminal from the second element to the first element.

20. The method of claim 15 wherein passing signaling information for the call between the first element and the second element comprises passing routing information from the first element to the second element.

21. The method of claim 20 wherein the routing information includes an identification of the other terminal, the other terminal being registered on the mobile network.

22. The method of claim 15 further comprising routing the call between the first element and the second element over the packet-based data network.

23. The method of claim 15 wherein the packet-based network comprises at least one of a public Internet and a private IP network.

24. A method of signaling comprising:
determining a first set of communication devices in a wireless network;
determining a second set of communication devices in a wireline network;
associating the first set of communication devices and the second set of communication devices;
receiving a call for one associated communication device; and
notifying the call to all the associated communication devices.

25. The method of claim 24 where the first set of communication devices includes a cellular phone and the set of communication devices in a wireline network includes a SIP phone, said cellular phone associated with the SIP phone
receiving a call for the SIP phone
notifying the call to the SIP phone and the cellular phone

26. The method of claim 9 where the first set of communication devices includes a dual wireless device and the set of communication devices in a wireline network includes a SIP phone, said dual wireless device associated with the SIP phone
receiving a call for the SIP phone
notifying the call to the SIP phone and the dual wireless device

27. The method of claim 26 where the dual wireless device is registered in a private wireless LAN
receiving a call for the SIP phone
notifying the call to the SIP phone and the dual wireless device

28. The method of claim 27, notifying the dual wireless device of the call in the private wireless LAN.

29. The method of claim 24 where the first set of communication devices includes a cellular phone and the set of communication devices in a wireline network includes a SIP phone, said cellular phone associated with the SIP phone
receiving a call for the cellular phone
notifying the call to the cellular phone and the SIP phone

30. The method of claim 24 where the first set of communication devices includes a dual wireless device and the set of communication devices in a wireline network includes a SIP phone, said a dual wireless device associated with the SIP phone
receiving a call for the a dual wireless device
notifying the call to the a dual wireless device and the SIP phone

31. The method of claim 30 where the dual wireless device is registered in a private wireless LAN
receiving a call for the dual wireless device
notifying the call to the dual wireless device and the SIP phone

32. The method of claim 31, notifying the dual wireless device in the private wireless LAN.

33. A communication system comprising:
a second element coupled to a mobile telephone network and to a packet-based data network over which a first element is accessible;
wherein the second element is configured to extend private telephone features provided by the first element to mobile terminals registered on the mobile network.

34. The system of claim 33 wherein the second element interfaces with the mobile telephone network as at least one of a mobile switching center (MSC) and a service control point (SCP).

35. The system of claim 33 further comprising the first element.

36. The system of claim 35 wherein the first element comprises a voice call server.

37. The system of claim 36 wherein the voice call server comprises at least one of an IP PBX and an IPP Centrex system.
